(19) United States
(12) Patent Application Publication
(10) Pub. No.: US 2025/0054659 A1
(43) Pub. Date: Feb. 13, 2025

(54) Wire Harness Product Clamping Device and Heat Shrink Machine

(71) Applicant: Tyco Electronics (Shanghai) Co., Ltd., Shanghai (CN)

(72) Inventors: Yiqun (Cham) Zhu, Shanghai (CN); Zhen Wang, Shanghai (CN)

(73) Assignee: Tyco Electronics (Shanghai) Co., Ltd., Shanghai (CN)

(21) Appl. No.: 18/796,900

(22) Filed: Aug. 7, 2024

(30) Foreign Application Priority Data
Aug. 10, 2023 (CN) 202322153294.9

(51) Int. Cl. H01B 13/012

(52) U.S. Cl. CPC H01B 13/01209

(57) ABSTRACT

A wire harness product clamping device includes a pair of cantilevers installed on a heat shrink machine and a plurality of wire harness fixtures that are different from one another and installed on the cantilevers to respectively clamp a plurality of wire harness products. The cantilevers are movable between a first position and a second position and rotatable between a use state and a storage state. The wire harness fixtures are outside the heat shrink machine to clamp the wire harness products when the cantilevers are in the use state and moved to the first position. A heat shrink tube on one of the wire harness products clamped by one of the wire harness fixtures is moved from outside of the heat shrink machine to inside of the heat shrink machine when the cantilevers are in the use state and moved from the first position to the second position.

### CROSS-REFERENCE TO RELATED APPLICATION

This application claims the benefit of the filing date under 35 U.S.C. § 119 (a)-(d) of Chinese Patent Application No. 202322153294.9, filed on Aug. 10, 2023.

### FIELD OF THE INVENTION

The present invention relates to a wire harness product clamping device for a heat shrink machine and a heat shrink machine comprising the wire harness product clamping device.

### BACKGROUND OF THE INVENTION

A wire harness product commonly includes a wire harness and a heat shrink tubing installed on the wire harness. In order to heat shrink the heat shrink tubing onto the wire harness, it is necessary to use a heat shrink machine. However, due to space limitations and limited applicability, the existing wire harness product clamping device built into the heat shrink machine can only hold an ordinary wire harness product and cannot hold other types of wire harness products, such as spliced wire harness products, wire harness products with crimped terminals, or wire harness products with multiple heat shrink tubes. Therefore, if it is desirable to heat shrink other types of wire harness products, a user can only rely on external wire harness product clamping devices. Existing external wire harness product clamping devices, however, are large, making installation, use, and disassembly inconvenient.

### SUMMARY OF THE INVENTION

A wire harness product clamping device includes a pair of cantilevers installed on a heat shrink machine and a plurality of wire harness fixtures that are different from one another and installed on the cantilevers to respectively clamp a plurality of wire harness products. The cantilevers are movable between a first position and a second position and rotatable between a use state and a storage state. The wire harness fixtures are outside the heat shrink machine to clamp the wire harness products when the cantilevers are in the use state and moved to the first position. A heat shrink tube on one of the wire harness products clamped by one of the wire harness fixtures is moved from outside of the heat shrink machine to inside of the heat shrink machine when the cantilevers are in the use state and moved from the first position to the second position.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a wire harness product clamping device and a safety cover according to an exemplary embodiment of the present invention, wherein the wire harness product clamping device is in the use state and moved to a first position;

FIG. 2 shows an illustrative perspective view of a wire harness product clamping device according to an exemplary embodiment of the present invention, wherein the wire harness product clamping device is in the use state and moved to a first position;

FIG. 3 shows an illustrative view of clamping the wire harness product onto the wire harness product clamping device shown in FIG. 1;

FIG. 4 shows an illustrative view of the wire harness product clamping device moved from the first position shown in FIG. 3 to the second position, wherein the heat shrink tubing on the clamped wire harness product is moved to the interior of the safety cover;

FIG. 5 shows an illustrative perspective view of a wire harness product clamping device according to an exemplary embodiment of the present invention, wherein the wire harness product clamping device is in the use state and moved to a second position; and

FIG. 6 shows an illustrative perspective view of a wire harness product clamping device and a safety cover according to an exemplary embodiment of the present invention, wherein the wire harness product clamping device is in a storage state and is moved to a second position.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

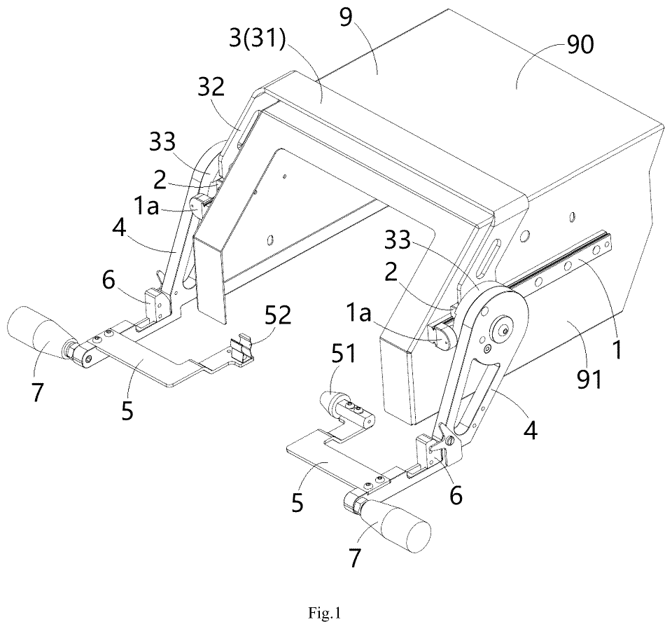

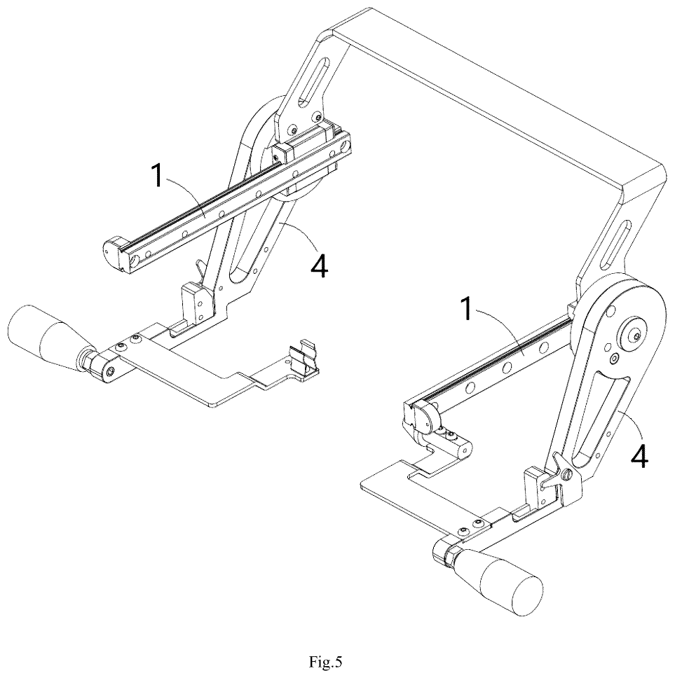

As shown in FIGS. 1 to 5, in an exemplary embodiment of the present invention, a wire harness product clamping device is disclosed. The wire harness product clamping device includes a pair of cantilevers 4 and a plurality of different wire harness fixtures 6, 51, and 52. The pair of cantilevers 4 are installed on a safety cover 9 of a heat shrink machine, can be moved between a first position and a second position, and can be rotated between a use state and a storage state. The different wire harness fixtures 6, 51, and 52 are installed on the cantilevers 4 to respectively clamp various wire harness products 8.

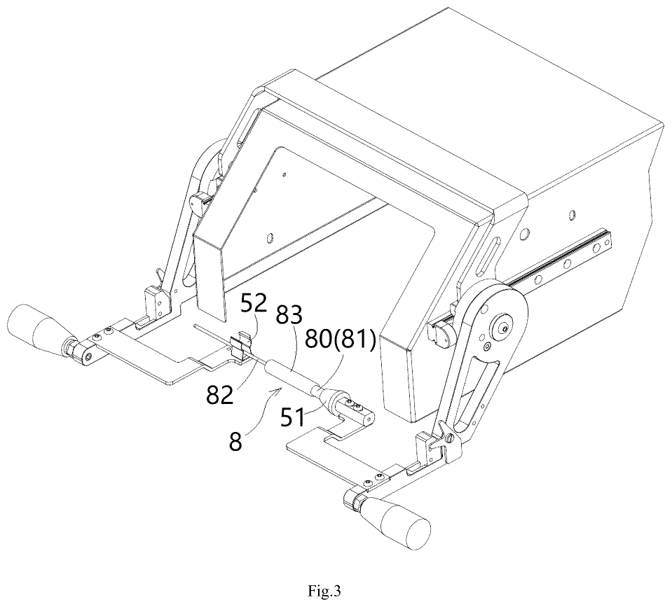

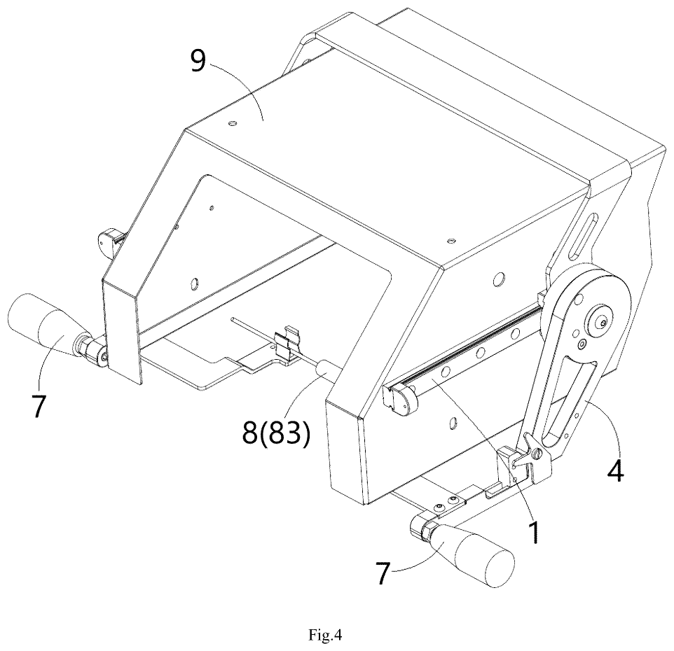

In the illustrated embodiment, the wiring harness product 8, as shown in FIGS. 3 and 4, includes a wiring harness 80 and a heat shrink tube 83 fitted onto the wiring harness 80. One of two ends 81 and 82 of the wire harness product 8 can be a wire harness extending from the heat shrink tube 83, a terminal pressed onto a single head wire harness, or the end of the heat shrink tube 83 fitted onto a single head wire harness.

When the pair of cantilevers 4 are in the use state and moved to the first position (as shown in FIGS. 1-3), the wire harness fixtures 6, 51, and 52 are located outside the safety cover 9 to facilitate clamping the wire harness product 8 onto the wire harness fixtures 6, 51, and 52.

When the pair of cantilevers 4 are in the use state and moved from the first position to the second position, the heat shrink tube 83 on the wire harness product 8 clamped by wire harness fixtures 6, 51, and 52 is moved from the outside of the safety cover 9 to the inside of the safety cover 9, as shown in FIG. 4, to heat the heat shrink tube 83.

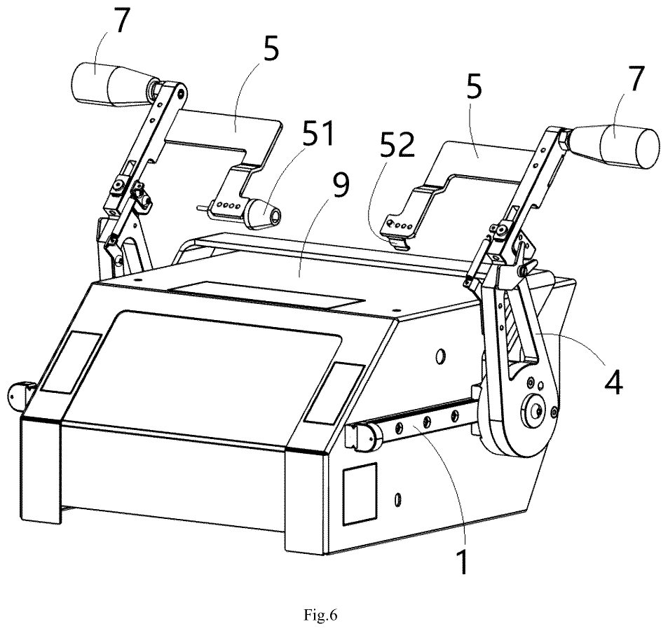

As shown in FIG. 6, in the illustrated embodiment, when the wire harness product clamping device is not in use, the pair of cantilevers 4 are rotated from the use state to the storage state and moved from the first position to the second position. In this way, it takes up less production space.

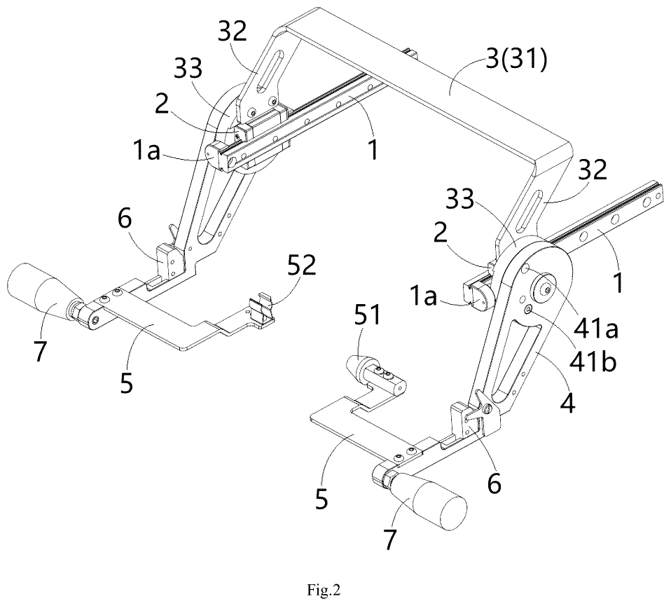

As shown in FIGS. 1 and 2, in the illustrated embodiments, the wire harness fixtures 6, 51, and 52 include a pair of first wire harness fixtures 6, which are respectively installed on the pair of cantilevers 4, suitable for respectively clamping two ends of a first wire harness product. The wire harness fixtures 6, 51, and 52 further include a pair of brackets 5 and a pair of second wire harness fixtures 51 and 52. The pair of brackets 5 are installed onto the pair of cantilevers 4. The pair of second wire harness fixtures 51 and 52 are respectively installed on the pair of brackets 5, suitable for clamping two ends 81 and 82 of a second wire harness product 8.

In the illustrated embodiment, as shown in FIG. 3, the two ends 81 and 82 of the second wiring harness product 8 are different from each other. The pair of second wire harness fixtures 51 and 52 are different from each other and suitable for respectively clamping the two ends 81 and 82 of the second wire harness product 8.

As shown in FIGS. 1 and 2, in the illustrated embodiments, the bracket 5 is detachably installed on the cantilever 4 or the second wire harness fixtures 51 and 52 are detachably installed on the brackets 5, allowing for quick replacement of the second wire harness fixtures 51 and 52. In this way, different wire harness fixtures can be quickly replaced to clamp different wire harness products 8.

As shown in FIG. 1, in the illustrated embodiments, the pair of cantilevers 4 are respectively installed on the outer sides of a pair of side walls 91 of the safety cover 9. When the pair of cantilevers 4 are in the use state and moved to the second position, the pair of first wire harness fixtures 6 are respectively located on the outside of the pair of side walls 91 of the safety cover 9, and the pair of second wire harness fixtures 51 and 52 are located inside the safety cover 9.

As shown in FIG. 1, in the illustrated embodiments, the wire harness product clamping device further comprises a pair of sliding rails 1 and a pair of sliders 2. The pair of sliding rails 1 are respectively fixed to the outer sides of the pair of side walls 91 of the safety cover 9. The pair of sliders 2 are slidably installed onto the pair of sliding rails 1 to be able to move along the pair of sliding rails 1. First ends of the pair of cantilevers 4 are respectively connected to the pair of sliders 2 to be able to move together with the pair of sliders 2.

The wire harness product clamping device further includes a bridging member 3, shown in FIGS. 1 and 2, which is bridged between the pair of sliders 2 to ensure synchronous movement of the pair of sliders 2 and the pair of cantilever arms 4. The bridging member 3 includes a pair of arms 32, a crossbeam 31, and a pair of mounting seats 33. The crossbeam 31 is connected between one ends of the pair of arms 32. The pair of mounting seats 33 are respectively fixed to the other ends of the pair of arms 32. The pair of sliders 2 are respectively fixed to the inner sides facing each other of the pair of mounting seats 33, and the first ends of the pair of cantilevers 4 are respectively connected to the outer sides of the pair of mounting seats 33. In the illustrated embodiments, the first ends of the pair of cantilevers 4 are rotatably connected to the pair of mounting seats 33, allowing the pair of cantilevers 4 to be rotated between the use state and the storage state.

As shown in FIG. 2, in the illustrated embodiments, a pin hole 41a is formed in the first end of the cantilever 4 and the mounting seat 33, and the wire harness product clamping device further includes a locking pin 41b corresponding with the pin hole 41a. When the pair of cantilevers 4 is in the use state or storage state, the locking pin 41b is inserted into the pin hole 41a to lock the pair of cantilevers 4 at the use state or the storage state. When it is necessary to rotate the pair of cantilevers 4, the locking pin 41b needs to be pulled out of the pin hole 41a.

The wire harness product clamping device further includes a pair of handles 7, shown in FIGS. 1 and 2, which are respectively fixed to the other ends of the pair of cantilevers 4, so that the pair of handles 7 can drive the pair of cantilevers 4 to move between the first and second positions and rotate between the use and storage states.

In the illustrated embodiments, the sliding rail 1 extends along a first horizontal direction, and the rotation axes of the pair of cantilevers 4 extend along a second horizontal direction perpendicular to the first horizontal direction.

As shown in FIGS. 1 and 2, in the illustrated embodiments, a limiting block 1a is provided at the end of sliding rail 1, which is suitable for pressing against slider 2 or mounting seat 33 to limit the pair of cantilevers 4 at the first or second position.

When the pair of cantilevers 4 is moved to the first position, shown in FIGS. 1 and 3, the brackets 5 on the pair of cantilevers 4 are in a position that does not interfere with the safety cover 9 to allow the pair of cantilevers 4 to rotate between the use state and the storage state. When the pair of cantilevers 4 is moved to the second position, shown in FIG. 4, the brackets 5 on the pair of cantilevers 4 are in a position that interferes with the safety cover 9, preventing the pair of cantilevers 4 from being rotated between the use and storage states. Therefore, in the present invention, when it is necessary to rotate the pair of cantilevers 4, the pair of cantilevers 4 must first be moved to the first position.

When use of the wire harness product clamping device is not required, the pair of cantilevers 4 are rotated from the use state to the storage state, shown in FIG. 6, and moved from the first position to the second position. When the wire harness product clamping device is required for use, the pair of cantilevers 4 are moved from the second position to the first position and rotated from the storage state to the use state.

In another exemplary embodiment of the present invention, a heat shrink machine is also disclosed. The heat shrink machine includes a safety cover 9, a heating device, and the aforementioned wire harness product clamping device. The wire harness product clamping device is used to clamp the wire harness product 8 and move the heat shrink tube 83 on the clamped wire harness product 8 to the inside of the safety cover 9, as shown in FIG. 4. The heating device is used to heat the heat shrink tube 83 that has been moved inside the safety cover 9.

When the pair of cantilevers 4 are in the use state, shown in FIG. 1, the wire harness fixtures 6, 51, and 52 are located below the bottom opening of the safety cover 9 to allow the heat shrink tubing 83 to enter the bottom opening of the safety cover 9. When the pair of cantilevers 4 are in the storage state, shown in FIG. 6, the wire harness fixtures 6, 51, and 52 are located above the top wall 90 of the safety cover 9, so as not to occupy production space.

The integral external wire harness product clamping device of the present invention does not occupy additional space and can be quickly expanded for use and folded up for storage without disassembly, making it very convenient to use. In the aforementioned exemplary embodiments of the present invention, the structure of the wire harness product clamping device is simple and compact, capable of clamping different wire harness products 8, and can be quickly expanded for use and folded up for storage without occupying production space.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A wire harness product clamping device, comprising:
a pair of cantilevers installed on a heat shrink machine, the cantilevers are movable between a first position and a second position and rotatable between a use state and a storage state; and
a plurality of wire harness fixtures that are different from one another and installed on the cantilevers to respectively clamp a plurality of wire harness products that are different from one another, the wire harness fixtures are outside the heat shrink machine to clamp the wire harness products when the cantilevers are in the use state and moved to the first position, a heat shrink tube on one of the wire harness products clamped by one of the wire harness fixtures is moved from outside of the heat shrink machine to inside of the heat shrink machine when the cantilevers are in the use state and moved from the first position to the second position.

2. The wire harness product clamping device of claim 1, wherein the cantilevers are installed on a safety cover of the heat shrink machine, the wire harness fixtures are outside the safety cover when the cantilevers are in the use state and moved to the first position, and the heat shrink tubing is moved from outside of the safety cover to inside of the safety cover when the cantilevers are in the use state and moved from the first position to the second position.

3. The wire harness product clamping device of claim 2, wherein the wire harness fixtures include a pair of first wire harness fixtures respectively installed on the cantilevers and clamping a pair of ends of a first wire harness product of the plurality of wire harness products.

4. The wire harness product clamping device of claim 3, wherein the wire harness fixtures include a pair of brackets which installed on the cantilevers and a pair of second wire harness fixtures respectively installed on the brackets and clamping a pair of ends of a second wire harness product of the plurality of wire harness products.

5. The wire harness product clamping device of claim 4, wherein the ends of the second wire harness product are different from each other, and the second wire harness fixtures are different from each other and suitable for respectively clamping the ends of the second wire harness product.

6. The wire harness product clamping device of claim 4, wherein each of the brackets is detachably installed on one of the cantilevers or each of the second wire harness fixtures is detachably installed on one of the brackets.

7. The wire harness product clamping device of claim 4, wherein the cantilevers are respectively installed on outer sides of a pair of side walls of the safety cover, the first wire harness fixtures are outside of the pair of side walls of the safety cover and the pair of second wire harness fixtures are inside the safety cover when the cantilevers are in the use state and moved to the second position.

8. The wire harness product clamping device of claim 7, further comprising a pair of sliding rails respectively fixed to the outer sides of the pair of side walls of the safety cover.

9. The wire harness product clamping device of claim 8, further comprising a pair of sliders respectively slidably installed on the pair of sliding rails and movable along the pair of sliding rails, a pair of first ends of the pair of cantilevers are respectively connected to the pair of sliders and move together with the pair of sliders.

10. The wire harness product clamping device of claim 9, further comprising a bridging member connected between the pair of sliders to ensure synchronous movement between the pair of sliders and the pair of cantilevers.

11. The wire harness product clamping device of claim 10, wherein the bridging member has:
a pair of arms;
a crossbeam connected between a pair of first ends of the pair of arms; and
a pair of mounting seats respectively fixed to a pair of second ends of the pair of arms, the pair of sliders are respectively fixed to a pair of inner sides facing each other of the pair of mounting seats, and the first ends of the pair of cantilevers are respectively connected to a pair of outer sides of the pair of mounting seats.

12. The wire harness product clamping device of claim 11, wherein the first ends of the pair of cantilevers are respectively rotatably connected to the pair of mounting seats to be rotated between the use state and the storage state.

13. The wire harness product clamping device of claim 12, wherein a pin hole is formed in the first end of each of the cantilevers and in each of the mounting seats, and further comprising a locking pin fitted in the pin hole to lock the pair or cantilevers when the pair of cantilevers is in the use state or the storage state.

14. The wire harness product clamping device of claim 12, further comprising a pair of handles respectively fixed to a pair of second ends of the pair of cantilevers, the pair of cantilevers are drivable by the pair of handles to move between the first position and the second position and to rotate between the use state and the storage state.

15. The wire harness product clamping device of claim 12, wherein each of the sliding rails extends along a first horizontal direction, and a rotation axis of the pair of cantilevers extends along a second horizontal direction perpendicular to the first horizontal direction.

16. The wire harness product clamping device of claim 11, wherein a limiting block is provided at an end of the sliding rails and presses against the sliders or the mounting seats to limit the pair of cantilevers at the first position or the second position.

17. The wire harness product clamping device of claim 4, wherein the brackets on the pair of cantilevers are in a position that does not interfere with the safety cover when the pair of cantilevers are moved to the first position so that the pair of cantilevers can be rotated between the use state and the storage state, and the brackets on the pair of cantilevers are in a position that interferes with the safety cover when the pair of cantilevers are moved to the second position so that the pair of cantilevers cannot be rotated between the use state and the storage state.

18. The wire harness product clamping device of claim 1, wherein the pair of cantilevers are rotated from the use state to the storage state and moved from the first position to the second position when the wire harness product clamping device is not in use, and the pair of cantilevers are moved from the second position to the first position and rotated from the storage state to the use state when the wire harness product clamping device needs to be used.

19. A heat shrink machine, comprising:
a safety cover;
a heating device for heating a heat shrink tube that is moved inside the safety cover; and
a wire harness product clamping device installed on the safety cover, the wire harness product clamping device clamps a wire harness product and moves the heat shrink tube on the wire harness product inside the safety cover, the wire harness product clamping device includes:
a pair of cantilevers movable between a first position and a second position and rotatable between a use state and a storage state; and
a plurality of wire harness fixtures installed on the cantilevers to clamp the wire harness product, the wire harness fixtures are outside the heating device to clamp the wire harness product when the cantilevers are in the use state and moved to the first position, the heat shrink tube clamped by the wire harness fixtures is moved from outside of the heating device to inside the heating device when the cantilevers are in the use state and moved from the first position to the second position.

20. The heat shrink machine of claim 19, wherein the wire harness fixtures are located below a bottom opening of the safety cover when the pair of cantilevers are in the use state, and the wire harness fixtures are located above a top wall of the safety cover when the pair of cantilevers are in the storage state.
